(19) United States
(12) Patent Application Publication
(10) Pub. No.: US 2012/0024062 A1
(43) Pub. Date: Feb. 2, 2012

(54) Low Cost Optical Accelerometer

(76) Inventors: Simeon E. Tiefel, Woodinville, WA (US); Webb T. Nelson, Woodinville, WA (US); Mark J. Chernick, Woodinville, WA (US); Vinnie Ryan, Woodinville, WA (US)

(21) Appl. No.: 12/847,918

(22) Filed: Jul. 30, 2010

(51) Int. Cl. G01P 15/08

(52) U.S. Cl. 73/514.26

(57) ABSTRACT

An accelerometer assembly and its method of operation. The accelerometer assembly is designed to be very low cost and robust. This enables the accelerometer assembly to be used in traditionally inexpensive consumer products. The accelerometer assembly uses one or more molded elastomeric structures. Each of the elastomeric structures has a flexible neck section and a head section that is supported by the flexible neck section. The head section of the elastomeric structure is placed between a light source and a photodetector. The head section partially obscures the photodetector from the light source. As the elastomeric structure experiences acceleration forces, the neck section flexes and the head section moves. This varies the degree in which the head section obscures the photodetector. The amount of light detected by the photodetector, therefore, becomes a measure of changing acceleration forces.

### BACKGROUND OF THE INVENTION

1. Field of the Invention

In general, the present invention relates to accelerometers that are used to detect and quantify changes in acceleration and/or orientation. More particularly, the present invention relates to accelerometers that detect changes in acceleration and/or orientation by placing an object in a path of light between a light source and an optical detector and measuring how changes in acceleration and orientation cause the object to interfere with the path of light.

2. Prior Art Description

There are many electronic and electro-mechanical devices that utilize small accelerometers. Accelerometers are devices that convert a change in acceleration into a corresponding electrical signal. As such, accelerometers are used in objects like video game controllers and smart phones to produce control signals when such objects are shaken or otherwise manually manipulated.

Gravity is an acceleration force that draws objects toward the earth. Consequently, any object that undergoes a change in position with respect to the earth also undergoes a change in relative acceleration forces. As such, accelerometers are also used in electronic devices to detect changes in orientation.

In the prior art record, there are many designs for accelerometers. Many simple accelerometers, called linear accelerometers, detect changes in acceleration in a single direction, that is in the X-axis, Y-axis or Z-axis. Accordingly, if a device requires that acceleration forces be accurately detected in more than one direction, then more than one linear accelerometer must be used. Although accelerometers do exist that can detect acceleration forces in multiple directions, such accelerometers tend to be much more complicated and expensive than linear accelerometers.

With growing advances in microelectronics, devices are becoming both smaller and more powerful. To service such electronic devices, accelerometers are being manufactured in smaller sizes. However, due to the functional nature of accelerometers, accelerometers typically have moving parts. Making a miniature accelerometer with moving parts requires a sophisticated manufacturing process and a large amount of expensive capital equipment. Consequently, although the size of accelerometers have been decreasing, the price of accelerometers has not.

The high price of accelerometers has excluded the use of accelerometers in many applications. Although an accelerometer may be no trouble to add to an expensive smart phone, accelerometers are difficult to add to inexpensive items that have small profit margins, such as toys. Toys typically do not use expensive electronics due to the cost and sophistication required to manufacture such components. The problem is compounded by the fact that many applications for accelerometers in toys require more than one accelerometer so that acceleration forces can be detected in more than one direction.

A need therefore exists for an accelerometer, that is small, inexpensive, and simple to manufacture. A need also exists for a simple accelerometer design that can detect acceleration forces in more than one direction, yet is small and easy to integrate into unsophisticated circuitry. These needs are met by the present invention as described and claimed below.

### SUMMARY OF THE INVENTION

The present invention is an accelerometer assembly and its method of operation. The accelerometer assembly is designed to be very low cost and robust. This enables the accelerometer assembly to be used in traditionally inexpensive consumer products, such as toys and novelties.

The accelerometer assembly includes one or more molded elastomeric structures. Each of the elastomeric structures has a flexible neck section and a head section that is supported by the flexible neck section. The head section of the elastomeric structure is placed between a light source and a photodetector. The head section partially obscures the photodetector from the light source. As the elastomeric structure experiences acceleration forces, the neck section flexes and the head section moves. This varies the degree in which the head section obscures the photodetector. The amount of light detected by the photodetector, therefore, becomes a measure of changing acceleration forces.

Since the elastomeric structures are molded, they can be produced in large quantities at very low cost. Consequently, the complete accelerometer assembly can be manufactured using only a few inexpensive components. Yet the accelerometer assembly is capable of great accuracy in detecting changes in acceleration and/or orientation.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a perspective view of an exemplary embodiment of an acceleration assembly;

FIG. 2 is a cross-sectional view of the embodiment of FIG. 1, viewed along section line 2-2;

FIG. 3 is a schematic showing no flex in the neck sections of the elastomeric structures; and

FIG. 4 is a schematic showing flex in the neck sections of the elastomeric structures in response to an applied acceleration force.

### DETAILED DESCRIPTION OF THE DRAWINGS

The present invention accelerometer assembly can be used to detect changes in acceleration and changes in orientation in a wide variety of circuits. In the exemplary embodiment of the accelerometer assembly being illustrated, the accelerometer assembly is embodied as a through-hole package for use on a printed circuit board. This embodiment is selected in order to set forth one of the best modes contemplated for the invention. The illustrated embodiment, however, is merely exemplary and should not be considered a limitation when interpreting the scope of the appended claims. The present invention accelerometer assembly can also be configured as a surface mounted component package, or as an isolated plug-in component.

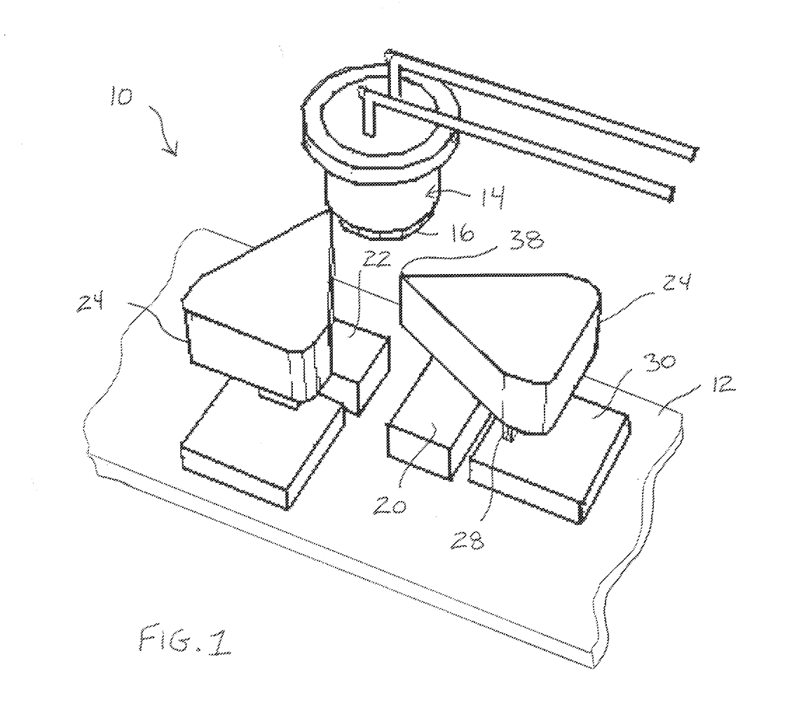

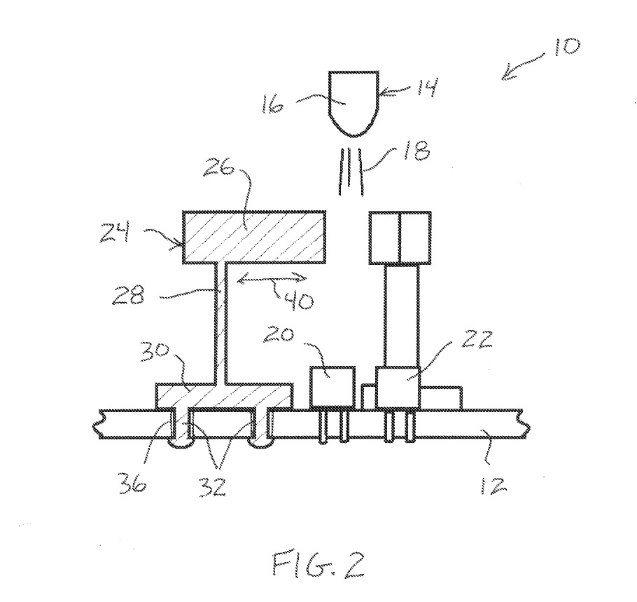

Referring to FIG. 1 and FIG. 2, an accelerometer assembly 10 is illustrated for used in a through-hole application upon a printed circuit board 12. The accelerometer assembly 10 includes a light source 14 that is mounted at an elevated position. The light source 14 is preferably a light emitting diode 16, however, other light sources can also be used. The light source 14 emits a beam of light 18 that is directed toward the circuit board 12.

Two photodetectors 20, 22 are mounted to the circuit board 12. The photodetectors 20, 22 generate an electrical signal or modify a preexisting electrical signal as a function of the intensity of the detected beam of light 18. Two elastomeric structures 24 are provided. The two elastomeric structures 24 are identical in form and are therefore referenced with the same numbers. Each of the elastomeric structures 24 mounts to the circuit board 12 adjacent one of the photodetectors 20, 22. The elastomeric structures 24 each have a head 26 that is supported upon a flexible neck 28. The head 26 of each elastomeric structure 24 is positioned to partially block the beam of light 18 as it travels between the light source 14 and the photodetectors 22, 24. The heads 26 move in response to changes in acceleration and/or orientation. The movement of the heads 26 causes the amount of the beam of light 18 being blocked to change. This either increases or decreases the intensity of the beam of light 18 impinging upon the photodetectors 20, 22. The change in detected intensity causes corresponding changes in the electrical signals created or modified by the photodetectors 20, 22. The changes in electrical signal therefore correspond to changes in acceleration of orientation that are required to produce such a signal. Consequently, the accelerometer assembly 10 is capable of detecting and quantifying changes in acceleration and/or orientation.

From FIG. 1 and FIG. 2, it can be seen that each of the elastomeric structures 24 have a base 30 that sits in contact with the circuit board 12. One or more attachment fingers 32 are molded onto the bottom of the base 30. The attachment fingers 32 have enlarged tips 34. The attachment fingers 32 are shaped and sized to pass through mounting holes 36 on a printed circuit board 12, thereby mechanically connecting the base 30 of the elastomeric structures 24 to the circuit board 12.

The head 26 of each elastomeric structure 24 is large enough to have a mass of at least one gram. Each head 26 illustrated is generally wedge-shaped, having a salient point 38. The salient point 38 is the part of the head 26 that extends into the beam of light 18 when the accelerometer assembly 10 is at rest. Although a wedge shape is shown for each head 26, other shapes, such as triangle shapes, diamond shapes and teardrop shapes that also have salient points can be used.

The heads 26 of each of the elastomeric structures 24 is supported at an elevated position by a flexible neck 28. The flexible neck 28 is preferably thin and wide so that it is more prone to bend in one plane rather than another. The direction in which the flexible neck 28 is prone to bending is the same direction in which the salient point 38 of the supported head 26 points.

The flexible necks 28 support the heads 26 under their centers of gravity. In this manner, when the accelerometer assembly 10 is at rest and the flexible necks 28 are in a vertical orientation, the heads 26 do not bend the flexible necks 28 in any one particular direction.

Each head 26 and neck 28 are part of a molded elastomeric structure 24. Each elastomeric structure 24 is preferably molded as a single piece in an injection mold. It is preferred that each elastomeric structure 24 be molded from a thermoplastic material such as thermoplastic rubber (TPR) or thermoplastic polyurethane (TPU) so that the flexibility of the elastomeric structures 24 does not vary much with changes in ambient temperature. The durometer of the thermoplastic material is preferably between shore A 10 to shore A 90, the preferred durometer being near shore A 60. The sensitivity of each of the elastomeric structures 24 can be customized for different applications, without changing the dimensions of the molded elastomeric structure, by changing the durometer of the thermoplastic material. Consequently, different elastomeric structures 24 that are adapted for different uses can be manufactured from a single injection molding tool. This greatly decreases the capital costs involved in manufacturing a variety of accelerometers.

In the shown accelerometer assembly 10, two elastomeric structures 24 are mounted to the circuit board 12 below the light source 14. Each elastomeric structure 24 has identical dimensions, being produced by the same injection mold. Both elastomeric structures 24 have flexible necks 28 that extend upwardly at a perpendicular to the plane of the circuit board 12. However, the two elastomeric structures 24 are offset from each other by 90 degrees. Consequently, one elastomeric structure 24 is prone to bending in the east/west direction, as indicated by double-headed arrow 40, while the other is prone to bending in the perpendicular direction in and out of the plane of the paper.

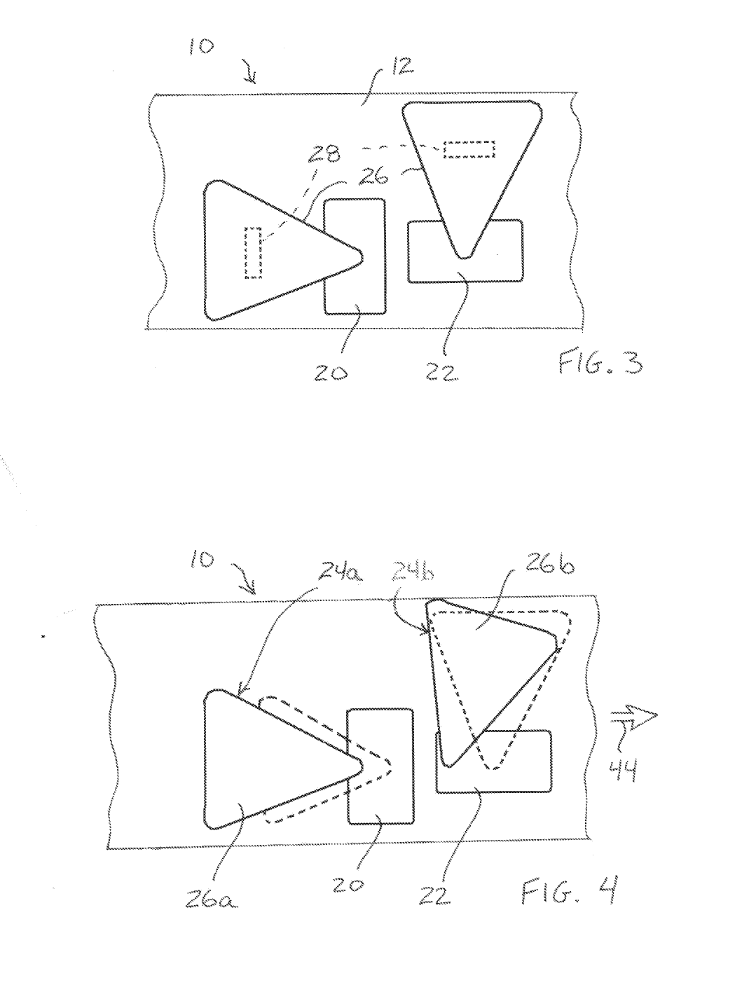

Referring to FIG. 3, it can be seen that when the accelerometer assembly 10 is at rest and the plane of the circuit board 12 is parallel to the ground, the flexible necks 28 do not bend. Rather, the necks 28 extend straight in the vertical. In this position, the two heads 26 block predetermined areas of the underlying photodetectors 20, 22. The photodetectors 20, 22 create or alter an electrical signal that is unique for this orientation.

Referring to FIG. 4, it can be seen that if the accelerometer assembly 10 is accelerated in the direction of arrow 44, or if the accelerometer assembly 10 were reoriented so that the arrow 44 were pointing upwardly in the vertical, then both elastomeric structures 24a, 24b respond. The elastomeric structure 24a prone to bending in the acting direction of acceleration force will have its flexible neck 28a bend backward in the direction opposite the direction of the acceleration. The degree of bending is directly proportional to the acceleration force experienced. The other elastomeric structure 24b will have its flexible neck 28b twist. This causes the two heads 26a, 26b to block light from the photodetectors 20, 22 to different degrees.

For any significant acceleration force encountered in any direction, the heads 26a, 26b of the two elastomeric structures 24a, 24b will move. This causes the heads 26a, 26b to block light from the photodetectors 20, 22 in different unique amounts. The combined degree of blockage created by the two heads 26a, 26b is unique for most all acceleration forces encountered. Consequently, by monitoring the signals produced from the photodetectors 20, 22, an accurate determination can be made regarding the direction and severity of acceleration forces.

In the shown embodiment, the accelerometer assembly 10 uses two elastomeric structures 24 that are offset by ninety degrees. Each elastomeric structure 24 blocks light from a single photodetector 20 22. It should be understood that in order to increase the accuracy of the accelerometer device 10, more than two elastomeric structures 24 can be used. For example, a third elastomeric structure can be used that is offset from both the illustrated elastomeric structures. Furthermore, accuracy can be increased by providing more than one photodetector for each of the elastomeric structures. If more than one photodetector is used, the direction of deflection can be more accurately determined.

In the shown embodiment, the accelerometer assembly 10 is shown mounted directly to a circuit board. It will be understood that the accelerometer assembly 10 can be encased within a protective housing (not shown). A protective housing can help protect the various elastomeric structures 24 from contamination from dirt, dust, and debris that may adversely affect the moving components.

It will be understood that the embodiment of the present invention that is illustrated and described is merely exemplary and that a person skilled in the art can make many variations to that embodiment. For instance, more than one light source can be provided. The head of the elastomeric structure can be varied, as can the shape and size of the flexible neck and base. All such embodiments are intended to be included within the scope of the present invention as defined by the claims.

What is claimed is:

1. An accelerometer assembly, comprising:
a first elastomeric structure having a neck section and a head section, wherein said head section is supported solely by said neck section and wherein said head section and said neck section are unistructurally molded from an elastomeric material;
a light source for producing a beam of light;
a photodetector aligned with said beam of light; and
wherein at least a portion of said head section protrudes into said beam of light, therein obscuring at least some of said beam of light from said photodetector.

2. The assembly according to claim 1, wherein said light source includes a light emitting diode.

3. The assembly according to claim 1, further including a second elastomeric structure, wherein said second elastomeric structure has a second neck section and a second head section unistructurally molded from elastomeric material.

4. The assembly according to claim 3, further including a second photodetector aligned to receive said beam of light, wherein at least a portion of said second head structure protrudes into said beam of light, therein obscuring at least some of said beam of light from said second photodetector.

5. The assembly according to claim 4, wherein said first elastomeric structure and said second elastomeric structure are identical in shape, size and composition.

6. The assembly according to claim 5, wherein said first elastomeric structure and said second elastomeric structure are offset from each other.

7. The assembly according to claim 1, wherein said first elastomeric structure has a base, and said neck section is anchored to said base.

8. The assembly according to claim 7, wherein said base and said neck section are unistructurally molded from said elastomeric material.

9. The assembly according to claim 8, further including a circuit board with through holes, wherein said base contains extensions that pass through said through holes, therein attaching said base to said circuit board.

10. The assembly according to claim 1, wherein said neck section is shaped to have a propensity to bend in a first direction.

11. The assembly according to claim 10, wherein said head section has a salient point that extends into said beam of light, wherein said salient point extends in said first direction.

12. An accelerometer assembly, comprising:
a plurality of elastomeric structures, each of said elastomeric structures having a flexible neck section and a head section that is supported by said flexible neck section;
at least one light source for producing at least one beam of light;
a plurality of photodetectors, wherein each of said photodetectors is aligned with said at least one beam of light; and
wherein at least a portion of each said head section protrudes into said at least one beam of light, therein obscuring at least some light from said photodetectors.

13. The assembly according to claim 12, wherein said flexible neck section and said head section of each of said elastomeric structures are unistructurally molded from elastomeric material.

14. The assembly according to claim 12, wherein all of said elastomeric structures are offset from one another.

15. The assembly according to claim 12, wherein each of said elastomeric structures is identical in shape, size, and composition.

16. The assembly according to claim 12, wherein each of said elastomeric structures has a base, where said neck section is anchored to said base.

17. The assembly according to claim 16, further including a circuit board with through holes, wherein said base contains extensions that pass through said through holes, therein attaching said base to said circuit board.

18. A method of detecting acceleration forces, comprising the steps of:
producing a beam of light;
providing a photodetector positioned to receive said beam of light;
molding an elastomeric structure having a head supported on a flexible neck;
positioning said elastomeric structure so that said head extends into said beam of light, therein obscuring some of said beam of light from said photodetector, wherein said flexible neck and said head move in response to changing acceleration forces.
